(19) United States
(12) Patent Application Publication
(10) Pub. No.: US 2014/0052302 A1
(43) Pub. Date: Feb. 20, 2014

(54) METHOD AND SENSOR NODE FOR MANAGING POWER CONSUMPTION AND POWER CONSUMPTION INFORMATION COLLECTION APPARATUS USING THE SAME

(71) Applicant: Electronics and Telecommunications Research Institute, (US)

(72) Inventor: Young Bag MOON, Daejeon (KR)

(73) Assignee: Electronics and Telecommunications Research Institute, Daejeon (KR)

(21) Appl. No.: 13/888,938

(22) Filed: May 7, 2013

(30) Foreign Application Priority Data
Aug. 20, 2012 (KR) 10-2012-0090461

(51) Int. Cl. G06F 1/32

(52) U.S. Cl. CPC G06F 1/3203
USPC 700/291

(57) ABSTRACT

A method for managing power consumption includes: sensing the power consumption of a power consuming device in real time; comparing the magnitude of the sensed power consumption to the magnitude of previous power consumption transmitted at a previous transmission interval; setting and registering the sensed power consumption as section maximum power consumption when the sensed power consumption is greater than the previous power consumption; generating power consumption data containing the sensed power consumption and the registered section maximum power consumption when a current time point arrives at a predetermined transmission interval; modulating the generated power consumption data into power consumption data which are to be wirelessly transmitted; and wirelessly transmitting the modulated power consumption data to a remote power management system.

### RELATED APPLICATIONS(S)

This application claims the benefit of Korean Patent Application No. 10-2012-0090461, filed on Aug. 20, 2012, which is hereby incorporated by references as if fully set forth herein.

### FIELD OF THE INVENTION

The present invention relates to a technique for managing power consumption, and more particularly, to a method and sensor mode for managing power consumption, which is suitable for managing the power consumption of power consuming devices (for example, semiconductor fabrication equipment, display fabrication equipment and the like) used in an industrial site using a sensor network, and a power consumption information collection apparatus using the same.

### BACKGROUND OF THE INVENTION

As is well known, a variety of fabrication equipment (product fabrication devices), required for producing various products, exists in industrial sites. Such fabrication equipment consumes a suitable amount of power when operated to fabricate products.

In particular, products such as semiconductors and displays require a large number of pieces of fabrication equipment in a production line thereof. Therefore, it is absolutely necessary to manage power consumption of the fabrication equipment while monitoring the power consumption of the fabrication equipment in real time.

Therefore, in a production site of industrial products, measurement equipment, such as an oscilloscope, are used to measure the power consumption of fabrication equipment and transmit the measured power consumption to a power consumption monitoring system to monitor and manage power consumption in the production site.

For this operation, the fabrication equipment is connected to respective pieces of measurement equipment, and the measurement equipment is connected to the power consumption monitoring system. Through such a configuration, the measurement equipment transmits the measured power consumption of the respective pieces of fabrication equipment to the power consumption monitoring system.

Patent Document 1: Korean Patent Laid-open Publication No. 2008-0090751 (published on Oct. 5, 2008)

As is well known, a production site for mass-producing industrial products generally occupies a large area. In such a production site, for example, a semiconductor fabrication site, a display panel fabrication site or the like, a plurality of production lines, each including at least several dozens of pieces of fabrication equipment arranged therein, is arranged at one production site (factory).

Therefore, in the case of a conventional system, in which measurement equipment is provided to measure the power consumption of fabrication equipment and transmit the measured power consumption to a power consumption monitoring system, the respective pieces of measurement equipment must be physically connected to the power consumption monitoring system. Therefore, space for installing the system in the vicinity of the production line is required, and complex operations for installing the system are required.

In particular, supposing that there is a plurality of production lines (for example, 10 production lines), each requiring at least several dozens of pieces of fabrication equipment, an unnecessarily high cost and an unnecessarily large space are required to construct a system for integrally monitoring and managing the power consumption of the respective production lines.

Furthermore, when production sites are physically located remotely from each other, it is more difficult to integrally monitor and manage the power consumption of entire production lines.

### SUMMARY OF THE INVENTION

In accordance with a first aspect of the present invention, there is provided a method for managing power consumption, including: sensing the power consumption of a power consuming device in real time; comparing the magnitude of the sensed power consumption to the magnitude of previous power consumption transmitted at a previous transmission interval; setting and registering the sensed power consumption as section maximum power consumption when the sensed power consumption is greater than the previous power consumption; generating power consumption data containing the sensed power consumption and the registered section maximum power consumption when a current time point arrives at a predetermined transmission interval; modulating the generated power consumption data into power consumption data which are to be wirelessly transmitted; and wirelessly transmitting the modulated power consumption data to a remote power management system.

In accordance with a second aspect of the present invention, there is provided a sensor node for managing power consumption, including: a power measurement block for sensing the power consumption of a power consuming device in real time; a power data management block for comparing the magnitude of the sensed power consumption to the magnitude of previous power consumption transmitted at a previous power transmission interval, registering the sensed power consumption as section maximum power consumption when the sensed power consumption is greater than the previous power consumption, and generating power consumption data containing the sensed power consumption and the registered section maximum power consumption when a current time point arrives at a predetermined transmission interval; and a power data transmission block for wirelessly transmitting the generated power consumption data to a remote power management system.

In accordance with a third aspect of the present invention, there is provided a power consumption information collection apparatus, including: a sensor node for generating power consumption data containing power consumption sensed from a power consuming device and section maximum power consumption information, set by comparing the magnitude of current power consumption to the magnitude of previous power consumption, and wirelessly transmitting the generated power consumption data; and a gateway for collecting the power consumption data of the power consuming device, which are wirelessly transmitted from the sensor node at predetermined transmission intervals, and transmitting the collected power consumption data toward a remote power management system.

### BRIEF DESCRIPTION OF THE DRAWINGS

The objects and features of the present invention will become apparent from the following description of embodiments given in conjunction with the accompanying drawings, in which:

FIG. 1 is a network configuration diagram of a system suitable for applying a sensor node for managing power consumption in accordance with the embodiment of the present invention;

FIG. 2 is a block configuration diagram of the sensor node for managing power consumption in accordance with the embodiment of the present invention;

FIG. 3 is a graph illustrating the real-time power consumption of a power consuming device; and

FIG. 4 is a flowchart illustrating main processes for managing power consumption using a sensor network in accordance with the embodiment of the present invention.

### DETAILED DESCRIPTION OF THE EMBODIMENTS

Hereinafter, exemplary embodiments of the present invention will be described below in more detail with reference to the accompanying drawings. The present invention may, however, be embodied in different forms, and should not be construed as being limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

Furthermore, the terms described below have been defined in consideration of functions in embodiments of the present invention, and may be defined differently depending on a user or operator's intention or practice. Therefore, the definitions of such terms are based on the overall descriptions in the present specification.

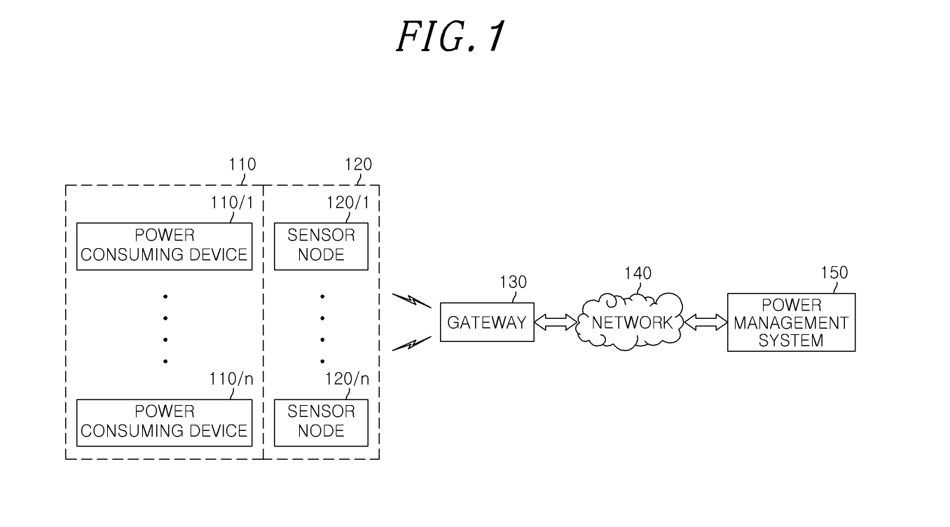

FIG. 1 is a network configuration diagram of a system suitable for applying a sensor node for managing power consumption in accordance with the embodiment of the present invention. The system may include a power consuming device group 110 composed of a plurality of power consuming devices 110/1 to 110/n, a sensor node group 120 composed of a plurality of sensor nodes 120/1 to 120/n, a gateway 130, a network 140, and a power management system 150.

Referring to FIG. 1, the respective power consuming devices of the power consuming device group 110 may include fabrication equipment used for fabricating products such as semiconductors, display panels, and various electronic elements. The power consuming device consumes power when operated to fabricate products.

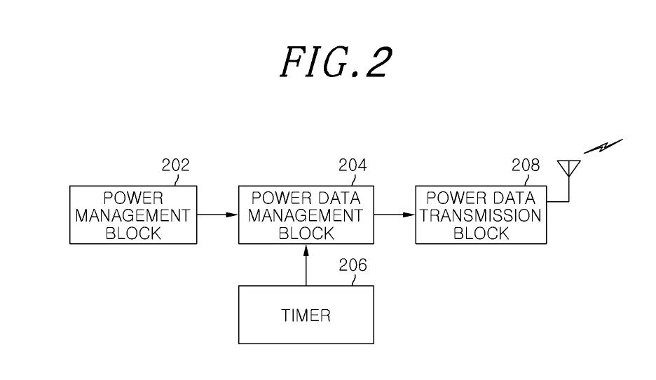

The respective sensor nodes of the sensor node group 120 are configured to sense the power consumption of the corresponding power consuming devices when the power consuming devices are operated (driven), generate power consumption data containing the detected power consumption and section maximum power consumption information, which is set by comparing the magnitude of current power consumption and the magnitude of previous power consumption at a predetermined transmission interval, and provide the generated power consumption data to the gateway 130 through a wireless network (for example, a near-field wireless communication network or the like). In order to provide such functions, each of the sensor nodes may be configured as illustrated in FIG. 2. The specific functions of the sensor node to implement the present invention will be described below in detail with reference to FIG. 2. The sensor node group 120 may be defined, for example, as a sensor network.

The gateway 130 is configured to collect power consumption data of the respective power consuming devices, which are received from the respective sensor nodes 110/1 to 110/n of the sensor node group 110 at predetermined intervals, and transmit the collected power consumption data to the remote power management system 150 through the network 140. The network 140 may indicate a wired communication network including the Internet, for example.

For this configuration, the gateway 130 may be connected to the respective sensor nodes 120/1 to 120/n of the sensor node group 120 through a wireless network, and may be connected to the power management system 150 through a wired network.

The power management system 150 may include a power management server to provide a power management and monitoring function for power consuming devices installed in a production line, a power management and monitoring function for production lines of a production site (factory), and a power management and monitoring function for production sties, based on the power consumption data of the respective power consuming devices collected through the gateway 130 and transmitted through the network 140 (power consumption data containing the power consumption of the respective power consuming devices and the previously registered section maximum power consumption information).

FIG. 1 illustrates only one gateway, for the convenience of description. Depending on the production line scales of production sites and the distribution of the production sites, several to several dozens of gateways may be installed.

FIG. 2 is a block configuration diagram of a sensor node for managing power consumption in accordance with the embodiment of the present invention. The sensor node may include a power measurement block 202, a power data management block 204, a timer 206, and a power data transmission block 208.

Referring to FIG. 2, the power measurement block 202 may include a power sensor and the like, and is configured to sense power consumption of a corresponding power consuming device (for example, 110/1) in real time at predetermined intervals (for example, several seconds or the like) when the power consuming devices 110/1 is operated to fabricate a product, and transmit the sensed power consumption to the power data management block 204.

The power data management block 204 is configured to compare the magnitude of the current power consumption to the magnitude of previous power consumption transmitted at a previous transmission interval when the current power consumption is collected by the power measurement block 202, set the current power consumption as the section maximum power consumption when the current power consumption is greater than the previous power consumption, and store the current power consumption in a memory (not illustrated).

Furthermore, the power data management block 204 is configured to generate power consumption data containing the collected power consumption and the previously registered section maximum power consumption information at a predetermined transmission interval (for example, several to several dozens of seconds) according to time information provided from the timer 206, and transmit the generated power consumption data to the power data transmission block 208. The predetermined transmission interval may be set to be longer than the predetermined interval at which the power measurement block 202 senses power consumption.

Here, the reason that the section maximum power consumption information is transmitted is in order to make the power management system check power consumption which varies in the section. For example, in the case of semiconductor, display process equipment or the like, a situation in which power is momentarily and rapidly consumed may occur. When such a situation occurs in the section, the section maximum power consumption is transmitted so that the power management system may check the section maximum power consumption.

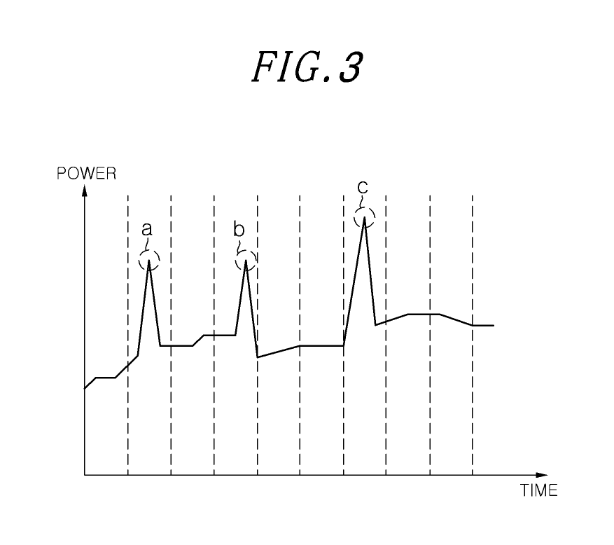

FIG. 3 is a graph illustrating the real-time power consumption of a power consuming device. In FIG. 3, the dotted line on the time axis indicates a periodical time interval at which a corresponding sensor node (for example, 120/1) transmits measured power consumption to the gateway 130, the solid line connecting the respective transmission intervals indicates measured power consumption, and power consumption a, b, and c, which momentarily rise, are registered as section maximum power consumption and then transmitted to the gateway 130 through the power data transmission block 208 together with next power consumption at the next transmission interval.

The power data transmission block 208 includes a transmission antenna for wirelessly transmitting power consumption data, for example, and is configured to modulate the power consumption data provided from the power data management block 204 into data which can be wirelessly transmitted, and to wirelessly transmit the modulated power consumption data toward the gateway 130 of FIG. 1 through the transmission antenna.

The power consumption data of the power consuming device 110/1, which are wirelessly transmitted toward the gateway 130 through the power data transmission block 208, may include identifier information of the corresponding power consuming device and/or identifier information of the corresponding sensor node. Through the identifier information, the power management system may perform a power management and monitoring function for the respective power consumption devices, the respective production lines, and the production sites.

Now, a series of processes for providing a service for managing power consumption using the sensor node for managing power consumption in accordance with the embodiment of the present invention will be described.

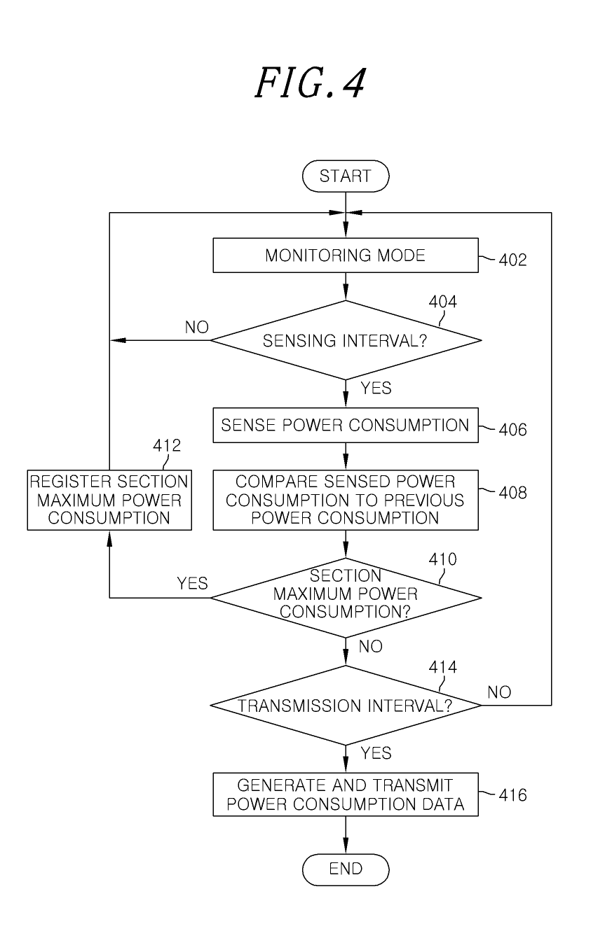

FIG. 4 is a flowchart illustrating main processes for managing power consumption using a sensor network in accordance with the embodiment of the present invention.

Referring to FIG. 4, while a sensor node (for example, 120/1) performs a monitoring mode at step S402, the power measurement block 202 checks whether or not a current time point arrives at a predetermined sensing interval (for example, several seconds), at step S404.

When it is verified at step S404 that the current time point has arrived at the predetermined sensing interval, the power measurement block 202 senses (measures) the power consumption of a corresponding power consuming device (for example, 110/1), and transmits the sensed power consumption to the power data management block 204 at step S406.

Then, the power data management block 204 compares the magnitude of previous power consumption transmitted at a previous transmission interval to the magnitude of the collected current power consumption at step S408. When determining that the collected current power consumption is greater than the previous power consumption at step S410, the power data management block 204 sets the collected current power consumption as section maximum power consumption and registers the section maximum power consumption in memory at step S412.

Then, the power data management block 204 checks whether or not the current time point has arrived at a predetermined transmission interval (for example, several to several dozens of seconds) based on time information provided from the timer 206, at step S414. The predetermined transmission interval may be set to be longer than the predetermined sensing interval at which the power measurement block 202 senses the power consumption of the corresponding power consumption device.

When it is verified at step S414 that the current time point has arrived at the predetermined transmission interval, the power data management block 204 generates power consumption data containing the collected power consumption and the previously registered section maximum power consumption information, and transmits the generated power consumption data to the power data transmission block 208. Then, the power data transmission block 208 modulates the power consumption data transmitted from the power data transmission block 204 into data which can be wirelessly transmitted, and wirelessly transmits the modulated data toward the gateway 130 through a transmission antenna, at step S416.

In accordance with the embodiments of the present invention, the power consumption of a power consuming device is sensed and collected in real time, the magnitude of the sensed power consumption is compared to the magnitude of previous power consumption, the sensed power consumption is set and registered as section maximum power consumption when the sensed power consumption is greater than the previous power consumption, and power consumption data containing the sensed power consumption and the registered section maximum power consumption are generated at a predetermined transmission interval and then wirelessly transmitted to the power management system. The complexity in installing the system for managing power consumption in the power consuming device may be reduced, and the installation cost and space may be reduced.

Meanwhile, combinations of respective blocks of the accompanying block diagrams may be formed using computer program instructions. Since the computer program instructions may be mounted in general computers, special computers or processors of programmable data processing equipment, the instructions executed through the computers or processors of other programmable data processing equipment generate units to perform the functions described in the respective blocks of the block diagrams. Since the computer program instructions may be stored in a computer-usable or computer-readable memory oriented to computers or other programmable data processing equipment in order to implement functions in a specific method, the instructions stored in the computer-usable or computer-readable memory may be used to manufacture products containing instruction units to perform the functions described in the respective blocks of the block diagrams. Since the computer program instructions may be mounted in computers or other programmable data processing equipment, instructions which perform a series of operation steps on the computers or other programmable data processing equipment to generate processes executed by the computers and operate the computers or other programmable data processing equipment may provide steps for performing the functions described in the respective blocks of the block diagram.

Furthermore, each of the blocks may indicate a part of a module, a segment or code including one or more executable instructions for executing specific logical functions. Furthermore, in some alternative embodiments, the functions described in the blocks may be performed in some other sequence. For example, the functions of two successive blocks may be performed substantially at the same time, or may be performed in reverse order depending on the corresponding functions.

While the invention has been shown and described with respect to the preferred embodiments, the present invention is not limited thereto. It will be understood by those skilled in the art that various changes and modifications may be made without departing from the scope of the invention as defined in the following claims.

What is claimed is:

1. A method for managing power consumption, comprising:
sensing power consumption of a power consuming device in real time;
comparing a magnitude of the sensed power consumption to a magnitude of previous power consumption transmitted at a previous transmission interval;
setting and registering the sensed power consumption as section maximum power consumption when the sensed power consumption is greater than the previous power consumption;
generating power consumption data containing the sensed power consumption and the registered section maximum power consumption when a current time point arrives at a predetermined transmission interval;
modulating the generated power consumption data into power consumption data which are to be wirelessly transmitted; and
wirelessly transmitting the modulated power consumption data to a remote power management system.

2. The method of claim 1, wherein the sensing the power consumption of the power consuming device comprises sensing the power consumption at an interval shorter than the predetermined transmission interval.

3. A sensor node for managing power consumption, comprising:
a power measurement block for sensing power consumption of a power consuming device in real time;
a power data management block for comparing a magnitude of the sensed power consumption to a magnitude of previous power consumption transmitted at a previous power transmission interval, registering the sensed power consumption as section maximum power consumption when the sensed power consumption is greater than the previous power consumption, and generating power consumption data containing the sensed power consumption and the registered section maximum power consumption when a current time point arrives at a predetermined transmission interval; and
a power data transmission block for wirelessly transmitting the generated power consumption data toward a remote power management system.

4. The sensor node of claim 3, wherein the power measurement block senses the power consumption of the power consuming device at an interval shorter than the predetermined transmission interval.

5. A power consumption information collection apparatus comprising:
a sensor node for generating power consumption data containing power consumption sensed from a power consuming device and section maximum power consumption information set by comparing a magnitude of current power consumption to a magnitude of previous power consumption, and wirelessly transmitting the generated power consumption data; and
a gateway for collecting the power consumption data of the power consuming device, which are wirelessly transmitted from the sensor node at a predetermined transmission interval, and transmitting the collected power consumption data toward a remote power management system.

6. The power consumption information collection apparatus of claim 5, wherein the sensor node senses the power consumption of the power consuming device at an interval shorter than the predetermined transmission interval.
